(19) United States
(12) Patent Application Publication
(10) Pub. No.: US 2026/0249217 A1
(43) Pub. Date: Aug. 27, 2026

(54) PERMEATE CARRIER WITH CIRCULAR DOUBLE KNIT FABRIC

(71) Applicant: LEAR CORPORATION, Southfield, MI (US)

(72) Inventors: David BURKE, Palmyra, PA (US); Abdur RAHAMAN SK, Philadelphia, PA (US); Tara SCHOFFSTALL, Auburn, PA (US)

(21) Appl. No.: 19/063,944

(22) Filed: Feb. 26, 2025

(51) Int. Cl. B01D 39/08

(52) U.S. Cl. CPC B01D 39/08; B01D 2201/31; B01D 2239/0216; B01D 2239/0609; B01D 2239/1291

(57) ABSTRACT

A system comprises a first filter membrane layer, a second filter membrane layer, a permeate carrier disposed between the first and the second membrane layers, and a core. The permeate carrier comprises a knitted fabric sheet comprising a first yarn and a second yarn knitted together in a circular knit pattern. The circular knit pattern comprises channels between the first yarn and the second yarn, and the permeate carrier supports the first and second filter membrane layers. The first filter membrane layer, the second filter membrane layer, and the permeate carrier are wound around the core.

### TECHNICAL FIELD

In at least one aspect, the present invention is related to filter elements for reverse osmosis, nanofiltration, ultrafiltration, or microfiltration systems; and in particular to, filter elements that include permeate carriers.

### BRIEF DESCRIPTION OF THE DRAWINGS

FIG. 1 is a schematic illustration of a water purification system, according to an embodiment.

FIG. 2A is a perspective view of the filter structure with a tear to expose layers of filtering elements, according to an embodiment.

FIG. 2B is a side view showing a plurality of filtering elements, according to an embodiment.

FIG. 3 is a schematic illustration of a face of a circular double-knit fabric sheet, according to an embodiment.

FIG. 4 is a cross section of a bicomponent yarn fiber.

FIG. 5 is a graph showing flow rates versus pressure performance comparing the permeate carrier according to an embodiment and conventional permeate carriers.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure. “One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Except in any examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. As used herein, the term “about” means that the amount or value in question may be the specific value designated or some other value in its neighborhood. The term “about” or “generally” denoting a certain value is intended to denote a range within +/−5% of the value. As one example, the phrase “about 10” denotes a range of 10+/−5, i.e. the range from 95 to 105. When the term “about” or “generally” is used, it can be expected that similar results or effects according to the invention can be obtained within a range of +/−5% of the indicated value. It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 10 includes 1, 2, 3, 4,. 97, 98, 99, 10. Similarly, when any range is called for, intervening numbers that are increments of the difference between the upper limit and the lower limit divided by 10 can be taken as alternative upper or lower limits. For example, if the range is 1.1 to 2.1 the following numbers 1.2, 1.3, 1.4, 1.5, 1.6, 1.7, 1.8, 1.9, and 2.0 can be selected as lower or upper limits.

Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

Water is in constant demand in both industrial and public settings. As such, processes to facilitate reclamation and purification of contaminated or impure water for potable reuse are desired. Some non-limiting examples of conventional water purification processes include biological activated sludge processes, biological nutrient removal processes, chemical processes such as softening, disinfection, and oxidation, and membrane processes including reverse osmosis, nanofiltration, ultrafiltration, and microfiltration. Depending on the type of process, the operating conditions may vary. Generally, some water purification methods via membrane processes operate under high pressures such that system components must be designed to stand up to the pressure to operate efficiently. In low pressure environments, these components have limited efficiency.

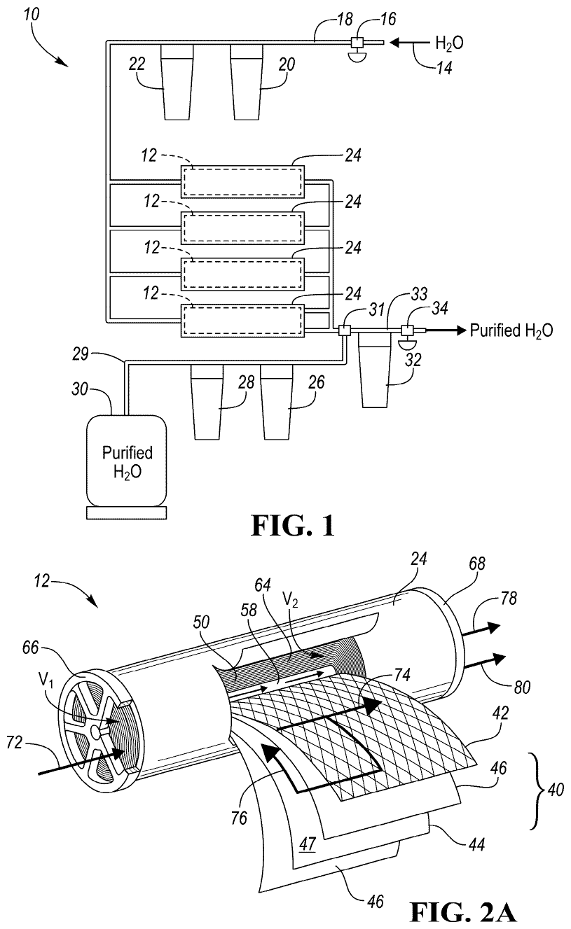

With reference to FIG. 1, a schematic illustration of a water purification system is provided. Water purification system 10 includes one or more filters 12. The water purification system 10 (and filters 12) can be used for reverse osmosis, nanofiltration, ultrafiltration, or microfiltration systems. The water purification system 10 includes a feed water source 14 fluidly connected via piping 18 to a control valve 16, which regulates or controls (e.g., on/off) the flow of the feed water into the piping 18. The feed water flows through the piping 18 to one or more filtration units 20, 22 prior to passing through filters 12, each of which is enclosed in a respective housing 24. The filtration units 20, 22 are any suitable filtration unit or combination of units other than membrane-based filters, such as, but not limited to, sediment filtration units including sand filters, carbon filtration units including activated carbon filters, softener filtration units including ion exchange filters, or kinetic degradation fluxion filtration units. Although two filtration units 20, 22 are shown, any suitable number of filtration units may be utilized based on various factors, such as, for example, system scaling. Similarly, although four filters 12 are shown, any suitable number of filters 12 may be utilized based on various factors, such as, for example, system scaling. After the water passes through the filter 12, the filtered water, in certain embodiments and as shown in FIG. 1, is routed via piping 19 to a splitter 31. The splitter 31 routes the filtered water into a first flow via piping 29 to pass through additional filtration units 26, 28 to generate purified water for storage in tanks 30. Although two filtration units 26, 28 are shown, any suitable number of filtration units may be utilized based on various factors, such as, for example, system scaling. The filtration units 26, 28 are any suitable filtration unit or combination of units other than membrane-based filters, such as, but not limited to, sediment filtration units including sand filters, carbon filtration units including activated carbon filters, softener filtration units including ion exchange filters, or kinetic degradation fluxion filtration units. The splitter 31 routes the filtered water into a second flow via piping 33 to pass through one or more filtration units 32 to form purified water which can be accessed or otherwise routed by a valve 34. Although one filtration unit 32 is shown, any suitable number of filtration units may be utilized based on various factors, such as, for example, system scaling. Similar to filtration units 20, 22, 26, 28, filtration unit 32 is any suitable filtration unit as described above. While the splitter 31 is shown forming two routes 29, 33 from piping 19, any suitable number of routes may be split from splitter 31, and the depiction of two routes is not intended to be limiting. For example, further routes may include additional filtration units to take purified water to additional storage tanks or other valves, and the like.

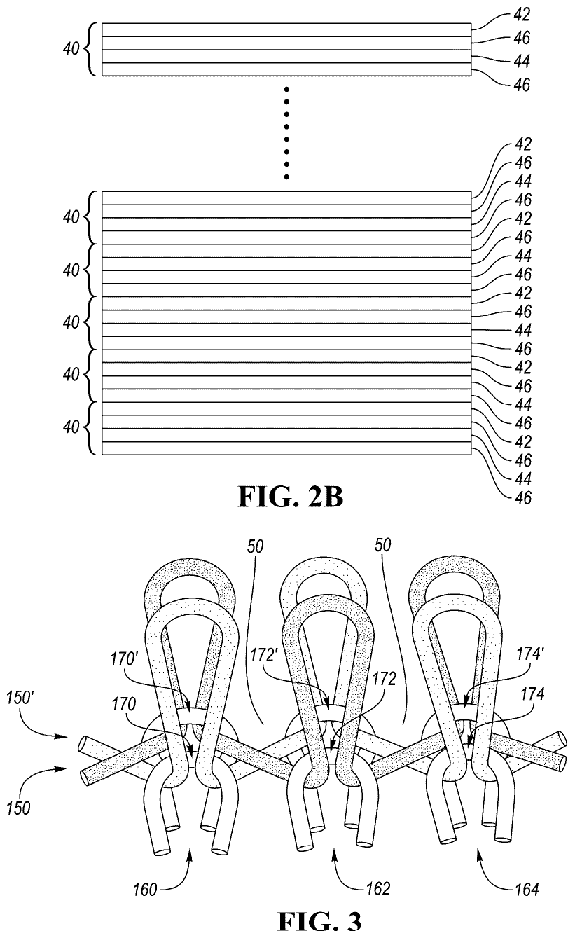

With reference to FIGS. 2A and 2B, a filter structure for reverse osmosis, nanofiltration, ultrafiltration, or microfiltration systems is provided. FIG. 2A is a perspective view of one of the filters 12 enclosed in the housing 24 with a tear in the housing 24 to expose a filtering element 40. FIG. 2B is a side view showing a plurality of filtering elements 40, 40′. Although six filtering elements 40, 40′ are shown, any suitable number of filtering elements may be utilized based on various factors, such as, for example, system scaling. The filter 12 includes the filtering element 40, which comprises a composite including a feed spacer 42, a permeate carrier 44, and a water filter membrane 46. As such, the filtering element 40 may be interchangeably referenced as the filtering element composite 40 or simply the composite 40. The permeate carrier 44 is constructed of a circular double-knit fabric sheet 47. The filter 12 may include any number of, or a plurality of composites 40. The number of composites 40 may vary as based on system pressure. Generally, the amount of permeate carriers or composites may be less for lesser pressure applications. In one embodiment, the filter 12 may include ten composites 40 and may operate at a system pressure of 1000 psi. In another embodiment, the filter 12 may include three composites 40 and may operate at a system pressure of 400 psi.

Referring again to FIGS. 2A and 2B, the permeate carrier 44 is positioned between two water filter membranes 46, and the feed spacer 42 is positioned on an outer side of one of the water filter membranes 46. In a variation, although not shown, the permeate carrier 44 may be positioned between a feed spacer 42 and a water filter membrane 46. The permeate carrier 44 structurally supports the water filter membranes 46 upon operating under pressure of the system in order to avoid collapsing of the filter membranes 46. The permeate carrier 44 comprising the circular double-knit fabric sheet 47 is a porous sheet that channels and directs water flow therethrough, and sustains a low pressure drop while withstanding pressure exerted without undergoing compaction. The channels 50 defined in the permeate carrier 44 define flow channels along a technical face and technical back of the knitted fabric for flow of water being filtered by the adjacent water filter membranes.

In at least one embodiment, referring again to FIG. 2B, the filter 12 includes additional filtering elements 40′ which are stacked over filtering element 40. The additional filtering elements 40′ as shown in FIG. 2B similarly comprise the permeate carrier 44 positioned between two water filter membranes, however other arrangements (e.g., the permeate carrier 44 between a water filter membrane and a feed spacer) and combinations of arrangements are also contemplated. These additional filtering elements 40′ overlap with each other and with the filtering element 40. The entire stack of filtering elements, including filtering elements 40, 40′, is wound around a perforated core 58, as show by end view V₁ and section view V₂ in FIG. 2A, to form a wound stack 64. The perforated core 58 is, in at least one embodiment, a perforated tube formed from suitable materials having sufficient mechanical strength and corrosion resistance, including, but not limited to, steel, stainless steel, polyvinyl chloride (PVC), acrylonitrile butadiene styrene (ABS), polypropylene (PP), polyphenylene ether (PPE), polyphenylene oxide (PPO), polysulfone (PSU) or the like. The wound stack 64 of filtering elements 40, 40′ attached to perforated core 58 is positioned in the housing 24 and held in place by end caps 66, 68.

Referring again to FIG. 2A, the filter 12 includes the perforated core 58 in direct contact with the feed spacer 42, however in other embodiments, although not shown, the perforated core 58 may be in direct contact with the permeate carrier 44. The perforated core 58 receives the filtered water that has passed through the water filter membrane 46 and the wound stack 64 into the interior of the perforated core 58. Arrow 72 indicates the introduction of feed water into the wound stack 64 of the filter 12, generally in an axial direction defined along the length the wound stack 64. The feed water flows over the feed spacer 42 in the axial direction as indicated by arrow 74. A portion of the feed water is filtered by flowing through the layers of the wound stack 64 and the water filter membrane 46, forming filtered water by moving radially inward through the layers of the wound stack 64 to the perforated core 58 as indicated by arrow 76. The filtered water exits the perforated core 58 as indicated by arrow 78. The concentrate water containing impurities exits the wound stack 64 of the filter 12 as a separate concentrate stream indicated by arrow 80. In this regard, the filtered water is water having less impurities than the feed water.

FIG. 3 is an illustration of a face of the circular double-knit fabric sheet 47 according to an embodiment. The circular double-knit fabric sheet 47 comprises synthetic yarns knitted into courses 150, 150′ and wales 160, 162, 164. The courses 150, 150′ comprise horizontal rows of loops of the yarns. The course 150 comprises horizonal rows of loops of the yarns on a first face of the fabric sheet 47 and the course 150′ comprises horizonal rows of loops of the yarns on a second face of the fabric sheet 47. The wales 160, 162, 164 comprise vertical columns of stitches 170, 170′, 172, 172′, 174, 174′. The stitches 170, 172, 174 are formed on the first face of the fabric sheet 47 by interlocking the yarn from a previous course with the yarn from the course 150. The stitches 170′, 172′, 174′ are formed on the second face of the fabric sheet 47 by interlocking the yarn from a previous course with the yarn from the course 150′. As the fabric sheet 47 is knit, the yarns alternate from the first face to the second face such that the yarns alternate forming a stich on the first face, e.g., the stitch 170, and forming a stitch on the second face, e.g., the stitch 172′. The wales 160, 162, 164 define channels 50 within the circular double-knit fabric sheet 47.

As set forth above, the permeate carrier 44 comprises a circular double-knit fabric sheet comprising synthetic yarns. In one aspect, the circular double-knit fabric sheet comprises a first yarn and a second yarn. The first yarn and the second yarn are, in some embodiments, different sizes and/or different materials. In one embodiment, the first yarn and the second yarn comprise the same material, but the denier of the first yarn is different than the denier of the second yarn. The first yarn and the second yarn are knitted together in a circular double-knit pattern. The circular double-knit pattern is formed using a weft knitting technique wherein a fabric sheet is formed comprising having two sides knitted together, e.g., interlocked. Accordingly, the circular double-knit fabric sheet includes a front face and a back face that are relatively smooth as opposed to, for example, a single-knit fabric sheet having a smooth front face and a back face comprising a series of raised ridges or ribs. The permeate carrier 44 is configured for placement between adjacent water filter membranes in a water filtration system.

The circular double-knit fabric sheet is generally formed using a circular knitting machine. A circular knitting machine forms fabric sheets having a tubular shape by knitting in a continuous direction rather than alternating back and forth between two directions. Accordingly, a circular knitting machine produces fabric sheets with lower time and energy input. In filtration systems operating at lower pressures (e.g., 60 to 500 psi in some embodiments, 200 to 500 psi in other embodiments), where the structural characteristics may be unnecessary, performance of a filter with a permeate carrier with the circular double-knit fabric is achieved with reduced input costs.

The permeate carrier 44 is also characterized by the thickness of the circular double-knit fabric sheet. According to an embodiment, the permeate carrier 44 comprises a thickness of about 5 to 15 millimeters. In a refinement, the thickness of the circular double-knit fabric sheet is from 9 to 11 millimeters. In another refinement, the thickness of the circular double-knit fabric sheet is 10.5 millimeters. A greater thickness of the permeate carrier 44 alter the flow channel geometry for permeate (e.g., water) flow therethrough. A thinner permeate carrier 44 increases flow resistance through the fabric sheet, thus requiring a higher energy input to maintain a constant volume water flow rate. The thickness of the permeate carrier 44 may also influence the packing density of the filter element composite and thus the purification system's overall capacity.

The thickness of the circular double-knit fabric sheet is, in some embodiments, influenced by the sizes and weights of the first and second yarns. Yarn denier (i.e., the mass of a fiber in grams per 9,000 meters) also influences the flow efficiency and the structural support provided by the permeate carrier 44 in various embodiments. The first and second yarns comprise a denier of about 40 to 100 in an embodiment, 40 to 80 in another embodiments, and 40 to 60 in yet another embodiment. In one aspect, the first yarn comprises a denier of about 40 to 60 and the second yarn comprises a denier of about 60 to 80. In yet another aspect, the first yarn comprises a denier of about 50 and the second yarn comprises a denier of about 70. In at least one embodiment, the second yarn has a denier greater than the first yarn.

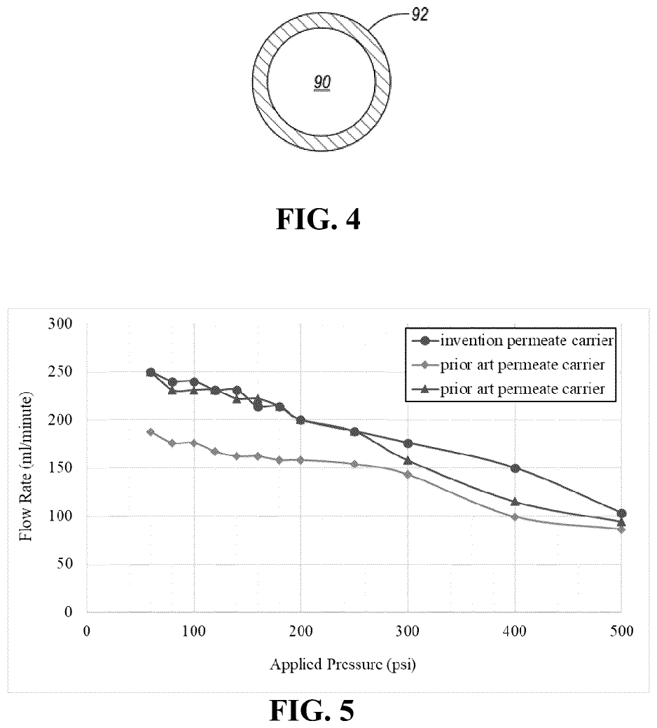

It should also be appreciated that the present invention is not limited by the type of yarn used for the circular double-knit fabric sheet. The synthetic yarns can be monofilament yarns or yarns that include a plurality of filaments. In a refinement, the synthetic yarns comprise a component including polyester yarns, polypropylene yarns, NYLON yarns, or combinations thereof. With reference to FIG. 4, the multifilament yarns in at least one embodiment comprise bicomponent yarns comprising an outer sheath region 92 and an inner core region 90. Such yarns are referred to as sheath-core yarns. In one aspect, the outer sheath region 92 has a lower melting point than the inner core 90. After knitting the circular double-knit fabric sheet, the fabric sheet is heated above the melting point of the outer sheath region 92 such that adjacent yarns are fused together. In a variation, a surface of the circular double-knit fabric sheet can be overcoated with a component layer having a lower melting point than the yarns. The component layer is any suitable thermoplastic polymer or thermosetting resin, and, in some embodiments, may be an epoxy layer.

FIG. 5 provides a graph of flow rates versus pressure performance for permeate carriers of an embodiment of the invention and two prior art permeate carriers. The example for the permeate carrier according to an embodiment shows similar flow rate maintenance compared to the closest tested prior art sample over a pressure range of 60 to 250 psi and an improvement in flow rate over a pressure range of 250 to 500 psi. According to an aspect of the present invention, a water flow rate of about 100 to 250 ml/min is provided at pressures between 60 and 500 psi. A 3-inch by 3-inch portion of the finished permeate carrier according to one embodiment was tested for flow properties against two similar prior art fabrics. Along with a support structure for the fabric comprised of tape layers and sample filtration membranes to simulate behavior in a section of real filtration conditions, the fabric is placed inside a pressurized chamber. Water is introduced into the system at a fixed pressure and funneled through the channels of the fabric being tested. Higher flow translates to better fabric performance for a finished filtration unit. A pressure is applied to the top of this fabric sample, which simulates a pressurized water filtration system. This pressure, as charted on the x-axis of FIG. 5, was increased to 500 psi and output flow was measured for multiple pressures.

### Aspects

Aspect 1. A system comprising: a first filter membrane layer, a second filter membrane layer, and a permeate carrier disposed between the first and the second membrane layers, the permeate carrier comprising a knitted fabric sheet comprising a first yarn and a second yarn knitted together in a circular knit pattern, the circular knit pattern comprising channels between the first yarn and the second yarn, the permeate carrier supporting the first and second filter membrane layers; and a core, wherein the first filter membrane layer, the second filter membrane layer, and the permeate carrier are wound around the core.

Aspect 2. The system of aspect 1, wherein the circular knit pattern comprises the first and second yarns looped horizontally to form a first row, with each stitch of the first row interlocking with a second row.

Aspect 3. The system of any one of aspects 1 to 2, wherein the first and second yarns comprise sheath core cross-sectional yarns.

Aspect 4. The system of any one of aspects 1 to 3, wherein the first and second yarns comprise a denier of about 40 to 100.

Aspect 5. The system of any one of aspects 1 to 4, wherein the first yarn comprises a denier of about 40 to 60 and the second yarn comprises a denier of about 60 to 80.

Aspect 6. The system of any one of aspects 1 to 5, wherein the first yarn comprises a denier of about 50 and the second yarn comprises a denier of about 70.

Aspect 7. The system of any one of aspects 1 to 6, wherein the knitted fabric sheet comprises a thickness of about 5 to 15 mm.

Aspect 8. The system of any one of aspects 1 to 7, wherein the knitted fabric sheet comprises a thickness of about 9 to 11 mm.

Aspect 9. The system of any one of aspects 1 to 8, wherein the knitted fabric sheet comprises a thickness of about 10.5 mm.

Aspect 10. The system of any one of aspects 1 to 9, wherein the first yarn and the second yarn alternate between a first face and a second face of the knitted fabric sheet to form courses at the first face and the second face, wherein the courses interlock with a previous course to form stitches at the first face and the second face.

Aspect 11. A system comprising: a first filter membrane; a second filter membrane; and a permeate carrier disposed between the first and second filter membranes, the permeate carrier comprising a knitted fabric comprising a first yarn and a second yarn knitted together in a circular knit pattern.

Aspect 12. The system of aspect 11, wherein water flow rate through the system is about 100 to 250 ml/min at water pressures between 60 and 500 psi.

Aspect 13. The system of any one of aspects 11 to 12, wherein the knitted fabric comprises a thickness of about 5 to 15 mm.

Aspect 14. The system of any one of aspects 11 to 13, wherein the knitted fabric comprises a thickness of about 9 to 11 mm.

Aspect 15. The system of any one of aspects 11 to 14, wherein the knitted fabric comprises a thickness of about 10.5 mm.

Aspect 16. A filter comprising: a composite comprising: a first filter membrane layer, a second filter membrane layer, and a permeate carrier disposed between the first and the second membrane layers, the permeate carrier comprising a knitted fabric sheet comprising a first yarn and a second yarn knitted together in a circular knit pattern and wherein the permeate carrier supports the first and second filter membrane layers; a feed spacer disposed adjacent to the composite; and a perforated core, wherein the composite and the feed spacer are wound around the core and the permeate carrier is a porous layer.

Aspect 17. The filter of aspect 16, further comprising a second composite, the second composite comprising a third membrane layer, a fourth membrane layer, and a second permeate carrier disposed between the third and the fourth membrane layers, the second permeate carrier comprising a second knitted fabric sheet and wherein the second permeate carrier supports the third and the fourth filter membrane layers.

Aspect 18. The filter of any one of aspects 16 to 17, wherein the perforated core comprises a perforated tube comprising steel, stainless steel, polyvinyl chloride, acrylonitrile butadiene styrene, polypropylene, polyphenylene ether, polyphenylene oxide, or polysulfone.

Aspect 19. The filter of any one of aspects 16 to 18, wherein water flow rate through the filter is about 100 to 250 ml/min at water pressures between 60 and 500 psi.

Aspect 20. The filter of any one of aspects 16 to 19, wherein the first and second yarns comprise a denier of about 40 to 100.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A system comprising:
a first filter membrane layer,
a second filter membrane layer, and
a permeate carrier disposed between the first and the second membrane layers, the permeate carrier comprising a knitted fabric sheet comprising a first yarn and a second yarn knitted together in a circular knit pattern, the circular knit pattern comprising channels between the first yarn and the second yarn, the permeate carrier supporting the first and the second filter membrane layers; and
a core,
wherein the first filter membrane layer, the second filter membrane layer, and the permeate carrier are wound around the core.

2. The system of claim 1, wherein the circular knit pattern comprises the first and second yarns looped horizontally to form a first row, with each stitch of the first row interlocking with a second row.

3. The system of claim 1, wherein the first and second yarns comprise sheath core cross-sectional yarns.

4. The system of claim 1, wherein the first and second yarns comprise a denier of about 40 to 100.

5. The system of claim 4, wherein the first yarn comprises a denier of about 40 to 60 and the second yarn comprises a denier of about 60 to 80.

6. The system of claim 5, wherein the first yarn comprises a denier of about 50 and the second yarn comprises a denier of about 70.

7. The system of claim 1, wherein the knitted fabric sheet comprises a thickness of about 5 to 15 mm.

8. The system of claim 7, wherein the knitted fabric sheet comprises a thickness of about 9 to 11 mm.

9. The system of claim 8, wherein the knitted fabric sheet comprises a thickness of about 10.5 mm.

10. The system of claim 1, wherein the first yarn and the second yarn alternate between a first face and a second face of the knitted fabric sheet to form courses at the first face and the second face, wherein the courses interlock with a previous course to form stitches at the first face and the second face.

11. A system comprising:
a first filter membrane;
a second filter membrane; and
a permeate carrier disposed between the first and second filter membranes, the permeate carrier comprising a knitted fabric comprising a first yarn and a second yarn knitted together in a circular knit pattern.

12. The system of claim 11, wherein water flow rate through the system is about 100 to 250 ml/min at water pressures between 60 and 500 psi.

13. The system of claim 11, wherein the knitted fabric comprises a thickness of about 5 to 15 mm.

14. The system of claim 12, wherein the knitted fabric comprises a thickness of about 9 to 11 mm.

15. The system of claim 13, wherein the knitted fabric comprises a thickness of about 10.5 mm.

16. A filter comprising:
a composite comprising:
a first filter membrane layer,
a second filter membrane layer, and
a permeate carrier disposed between the first and the second membrane layers, the permeate carrier comprising a knitted fabric sheet comprising a first yarn and a second yarn knitted together in a circular knit pattern and wherein the permeate carrier supports the first and the second filter membrane layers;
a feed spacer disposed adjacent to the composite; and
a perforated core, wherein the composite and the feed spacer are wound around the core and the permeate carrier is a porous layer.

17. The filter of claim 16, further comprising a second composite, the second composite comprising:
a third filter membrane layer,
a fourth filter membrane layer, and
a second permeate carrier disposed between the third and the fourth membrane layers, the second permeate carrier comprising a second knitted fabric sheet and wherein the second permeate carrier supports the third and the fourth filter membrane layers.

18. The filter of claim 16, wherein the perforated core comprises a perforated tube comprising steel, stainless steel, polyvinyl chloride, acrylonitrile butadiene styrene, polypropylene, polyphenylene ether, polyphenylene oxide, or polysulfone.

19. The filter of claim 16, wherein water flow rate through the filter is about 100 to 250 ml/min at water pressures between 60 and 500 psi.

20. The filter of claim 16, wherein the first and second yarns comprise a denier of about 40 to 100.
